(19) United States
(12) Patent Application Publication
(10) Pub. No.: US 2005/0150560 A1
(43) Pub. Date: Jul. 14, 2005

(54) Diaphragm valve

(76) Inventor: Jerry Amato, Yorktown Heights, NY (US)

Correspondence Address: PEARNE & GORDON LLP, 1801 EAST 9TH STREET, SUITE 1200, CLEVELAND, OH, 44114-3108, US

(21) Appl. No.: 10/753,242

(22) Filed: Jan. 8, 2004

(51) Int. Cl. F16K 11/04

(52) U.S. Cl. 137/863

(57) ABSTRACT

A diaphragm valve has a first, second, and third ports, each of which for fluid entry or exit, and an adjustable diaphragm. In one aspect, a housing of the valve has at least a portion made from a transparent material such that the diaphragm is visible during operation of the valve. In another aspect, the valve includes a plastic housing having a metallic threaded portion to receive a compatibly threaded fastener to secure a periphery of the diaphragm to the housing. In another aspect, the valve also includes a plurality of fins disposed on the housing and axially extending along a branched portion of the interior passage.

### FIELD OF THE INVENTION

The present invention is directed in general to valves, and more particularly to a low-noise diaphragm valve allowing visual inspection of a diaphragm position while the diaphragm valve is operational.

### BACKGROUND OF THE INVENTION

Conventional three-way diaphragm valves direct fluid entering the diaphragm valve through one of two possible outlet ports to a desired destination by adjusting the position of a diaphragm. Having the shape of a “T,” conventional three-way diaphragm valves include a through portion, represented by the horizontal member of the T, and a branched portion represented by the vertical portion. The diaphragm, typically disposed at the intersection of the two members, interferes with the fluid flowing through the diaphragm valve to direct the fluid through an appropriate interior passage leading to the desired outlet port. Air, or other suitable fluid, can be introduced or removed from one side of the diaphragm to pneumatically adjust the diaphragm position to appropriately direct the fluid.

When the diaphragm is adjusted to extend into an interior passage of the diaphragm valve, the diaphragm typically engages a surface within the diaphragm valve. In this position, the diaphragm directs the flow of the fluid through the branched portion of the interior passage. Fluids flowing at rapid flow rates and/or at elevated pressures can leak through an interface between the diaphragm and the surface within the diaphragm valve, thereby allowing an amount of the fluid to exit through an undesired outlet port. If left undetected, such leaks can be detrimental to the overall performance of the plumbing network, and can develop into a more substantial leak.

Improper operation of a diaphragm valve can also arise when a diaphragm actuation mechanism malfunctions and the diaphragm fails to be adjusted to one of its fluid directing positions. When this occurs, the fluid intended to be directed through a desired outlet port is erroneously discharged through the other outlet port. To permit indirect observation of the diaphragm's position during operation of the diaphragm valve, a rod typically extends from the diaphragm into an actuation chamber, which is an enclosure on a side of the diaphragm opposite of the interior passage through which the fluid flows through the diaphragm valve. For a pneumatically actuated diaphragm valve, air is introduced to, or removed from, the actuation chamber to expand or retract the diaphragm position, respectively. The rod includes an indicator disposed at an end of the rod that is extended away from the diaphragm such that the indicator rises and falls with the adjustment of the diaphragm. A transparent window disposed in a cap enclosing the diaphragm valve allows the indicator to be observed through the window when the diaphragm is adjusted to an elevated position. Air introduced into the actuation chamber forces the diaphragm in a downward direction. When this occurs, the downward motion of the diaphragm lowers the indicator such that it is no longer visible through the window. Visual inspection of the indicator's position through the window indicates the current position of the diaphragm. Such a system of providing a visual indicator of the diaphragm's position adds to the complexity of the diaphragm valve, thereby increasing the cost of its manufacture.

Certain diaphragm valves employ a valve stem that extends from the diaphragm axially through the branched portion of the interior passage. Such valve stems typically support a plunger that blocks the entrance to the branched portion of the interior passage when the diaphragm is adjusted to the appropriate position. As the diaphragm is adjusted to direct the flow of fluid through the branched portion the valve stem is translated axially in the branched portion to adjust the position of the plunger, thereby opening the entrance to the branched portion. Fluid flows through the branched portion, around the valve stem and through an outlet port as it exits the diaphragm valve. Turbulent fluid flow around the valve stem causes the valve stem to repeatedly contact interior surfaces of the diaphragm valve causing a disruptive noise, commonly referred to as “chatter.”

Attempts to eliminate chatter from diaphragm valves during their operation include providing a circular ring to the interior of the branched portion, or extending out of the branched portion, through which the valve stem slides as it is adjusted. The ring is generally held concentrically in place within the branched portion by protrusions extending from an interior periphery of the housing that defines the branched portion. In this position, the extended end of the valve stem passes through the ring as the valve stem's position is adjusted. Although it is positioned to allow the valve stem to pass therethrough, the ring disrupts the flow of fluid passing through the branched portion and out of the associated outlet port.

A periphery of the diaphragm is typically secured between the housing of the diaphragm valve and a cap releasably secured to the diaphragm valve via a threaded fastener that extends through threaded portions in the cap and housing. Each actuation of the diaphragm imparts a force on the connection established by the threaded portions and the threaded fastener. Being made of a plastic, the threaded portions of the diaphragm valve and the cap will wear over time and cannot be easily repaired. When the threaded portions are sufficiently deteriorated, the periphery of the diaphragm can move while secured to the diaphragm valve. When this occurs, the diaphragm may not properly partition the interior passage of the diaphragm valve from the actuation chamber, causing improper adjustment of the diaphragm and possible contamination of the fluid flowing through the diaphragm valve.

It would be beneficial to provide a low-cost diaphragm valve that allows visual observation of the diaphragm position and possible leaks between the diaphragm and a cooperating surface while the diaphragm valve is in use and without requiring a portion of the diaphragm valve to be dismantled. Additionally, the diaphragm valve should be able to secure the periphery of the diaphragm in a manner to maximize the useful life of the diaphragm valve, and should operate with a minimal amount of noise.

### SUMMARY OF THE INVENTION

In accordance with one aspect, the present invention provides a diaphragm valve for selectively directing a fluid to one or more of a plurality of destinations. The diaphragm valve includes a first port through which the fluid is to enter or exit the diaphragm valve to be directed to one or more of the plurality of destinations. The valve includes a second port through which the fluid is to exit the diaphragm valve en route to a first destination. The valve includes a third port through which the fluid is to exit the diaphragm valve en route to a second destination. The valve includes a diaphragm adjustable between a first position and a second position. The fluid that enters the diaphragm valve will be discharged from the diaphragm valve generally through the second port while the diaphragm is positioned at the first position, and the fluid that enters the diaphragm valve will be discharged from the diaphragm valve generally through the third port while the diaphragm is positioned at the second position. The valve includes a housing having at least a portion made from a transparent material such that the diaphragm is visible during operation of the valve. The housing defines an interior passage between the first, second and third ports.

In accordance with another aspect, the present invention provides a diaphragm valve for selectively directing a fluid to one or more of a plurality of destinations. The diaphragm valve includes a first port through which the fluid is to enter the diaphragm valve to be directed to one or more of the plurality of destinations. The valve includes a second port through which the fluid is to exit the diaphragm valve en route to a first destination. The valve includes a third port through which the fluid is to exit the diaphragm valve en route to a second destination. The valve includes a diaphragm adjustable between a first position and a second position. The fluid that enters the diaphragm valve will be discharged from the diaphragm valve generally through the second port while the diaphragm is positioned at the first position, and the fluid that enters the diaphragm valve will be discharged from the diaphragm valve generally through the third port while the diaphragm is positioned at the second position. The valve includes a plastic housing having a metallic threaded portion to receive a compatibly threaded fastener to secure a periphery of the diaphragm to the housing.

In accordance with one aspect, the present invention provides a diaphragm valve for selectively directing a fluid to one or more of a plurality of destinations. The diaphragm valve includes a first port through which the fluid is to enter the diaphragm valve to be directed to one or more of the plurality of destinations. The valve includes a second port through which the fluid is to exit the diaphragm valve en route to a first destination. The valve includes a third port through which the fluid is to exit the diaphragm valve en route to a second destination. The valve includes a diaphragm adjustable between a first position and a second position. The fluid that enters the diaphragm valve will be discharged from the diaphragm valve generally through the second port while the diaphragm is positioned at the first position, and the fluid that enters the diaphragm valve will be discharged from the diaphragm valve generally through the third port while the diaphragm is positioned at the second position. The valve includes a housing defining an interior passage through which the fluid that enters the diaphragm valve will travel to exit the diaphragm valve through at least one of the second and third ports. The valve also includes a plurality of fins disposed on the housing and axially extending along a branched portion of the interior passage.

In accordance with one aspect, the present invention provides a diaphragm valve for selectively directing a fluid to one or more of a plurality of destinations. The diaphragm valve includes a first port through which the fluid is to enter the diaphragm valve to be discharged at one or more of the plurality of discharge locations. The valve includes a second port through which the fluid is to exit the diaphragm valve at a first discharge location. The valve includes a third port through which the fluid is to exit the diaphragm valve at a second discharge location. The valve includes a diaphragm adjustable between a first position and a second position. The fluid that enters the diaphragm valve will be discharged from the diaphragm valve generally through the second port while the diaphragm is positioned at the first position. The fluid that enters the diaphragm valve will be discharged from the diaphragm valve generally through the third port while the diaphragm is positioned at the second position. The valve includes a transparent plastic housing defining an interior passage through which the fluid that enters the diaphragm valve will travel to be discharged from at least one of the second and third ports. The valve includes a plurality of fins disposed on the housing and axially extending along a branched portion of the interior passage. The valve includes a metallic threaded portion provided to the housing to cooperate with a compatibly threaded fastener to secure a periphery of the diaphragm to the housing.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of an illustrative arrangement of a diaphragm valve in accordance with the present invention;

FIG. 2 is an illustrative cross-sectional view of the diaphragm valve taken along line 2-2, the diaphragm being adjusted to a first position;

FIG. 3 is a view of the diaphragm valve similar to FIG. 2, but with the diaphragm being adjusted to a second position; and

FIG. 4 is an illustrative bottom view into an arrangement of a branched portion of a diaphragm valve in accordance with the present invention.

### DETAILED DESCRIPTION OF AN ILLUSTRATIVE EMBODIMENT

Certain terminology is used herein for convenience only and is not to be taken as a limitation on the present invention. Further, in the drawings, certain features may be shown in somewhat schematic form.

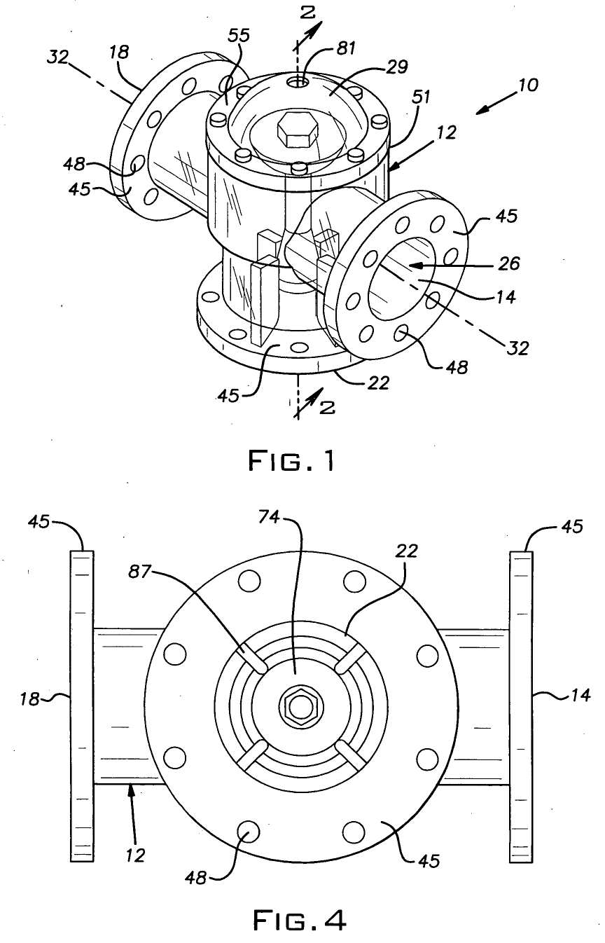

FIG. 1 shows an illustrative embodiment of a diaphragm valve 10 in accordance with the present invention. According to this embodiment, the diaphragm valve 10 generally includes a housing 12 having first, second and third ports, 14, 18 and 22, respectively, and a generally tubular interior passage 26 to provide fluid communication therebetween. A diaphragm 29 is adjustably coupled to the housing 12 in a manner to control fluid flow within the diaphragm valve 10. The position of the diaphragm 29 determines which of the three ports 14, 18, 22 through which the fluid will exit the diaphragm valve 10 en route to a desired destination. Such an arrangement is typically referred to as a “three-way” diaphragm valve 10 owing to its three ports 14, 18, 22 through which the fluid passes. However, diaphragm valves 10 having two or more ports are considered within the scope of the present invention.

The housing 12 of the illustrative embodiment is illustrated in FIGS. 1, 2 and 3 as generally T-shaped with the first port 14 oriented coaxially with the second port 18 along axis 32. Oriented in this manner, the first port 14 and the second port 18 mark the ends of a through portion 35 of the interior passage 26. The through portion 35 is a generally cylindrical shaped interior passage through which the fluid can pass through the diaphragm valve 10 generally parallel to axis 32. As illustrated in FIGS. 1, 2 and 3, the through portion 35 of the interior passage 26 is generally linear so that the bulk fluid in the through portion 35 does not encounter a significant change of direction between the first port 14 and the second port 18.

A branched portion 38 of the interior passage 26 extends at a generally perpendicular angle from the through portion 35, defining a generally cylindrical interior passage that extends to the third port 22. Fluid can flow between the branched portion 38 and the through portion 35 via an aperture 42 (FIG. 3) located at a point of intersection between the through portion 35 and the branched portion 38. A flange 45 with coupling means 48 is provided to each of the ports 14, 18, 22 to allow the diaphragm valve 10 of the present invention to be removably coupled to a plumbing network (not shown). The coupling means 48 is any known device for coupling a valve to a plumbing network such as internally threaded receptors, externally threaded members, clamps, bolts, screws, rivets, or the like.

Although an arrangement of the housing 12 in accordance with the illustrative embodiment is described in detail above, this is merely an example to describe one of the many possible housing 12 arrangements of the present invention. Other arrangements such as a Y-shaped housing, or any other shaped housing, are equally within the scope of the present invention. Further, the fluid may enter and/or exit through any of the ports 14, 18, 22, or, at least one of the ports may be dedicated as an inlet and/or outlet port.

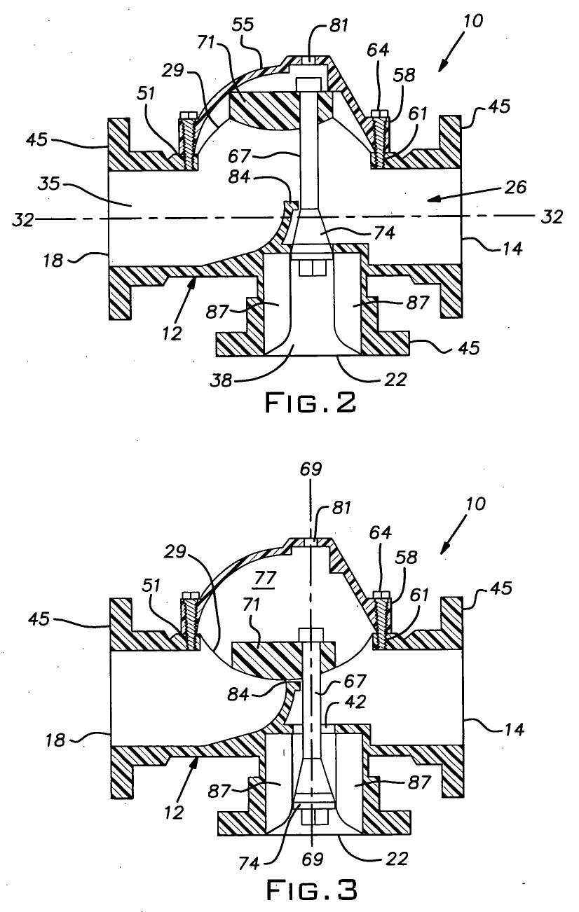

Best shown in FIGS. 2 and 3, the diaphragm 29 is a generally circular shaped piece of material that is suitably flexible and durable to withstand stresses encountered during repeated adjustment of its position between first and second positions. A periphery 51 of the diaphragm 29 is secured to the housing 12 by a cap 55 that is removably coupled to the housing 12. With the cap 55 in place on the housing 12, threaded recesses 58 formed in the cap 55 are horizontally aligned in vertical registry with threaded recesses 61 formed in the housing 12. Both the recesses 58 and the recesses 61 are arranged in a circular pattern similar in shape to the periphery 51 of the diaphragm 29. Conventional externally threaded mechanical fasteners 64 such as screws, bolts, or other similar fasteners are inserted through the aligned recesses 58, 61 to secure the cap 55 to the housing 12 with the periphery 51 of the diaphragm therebetween. The mechanical fasteners 64 can optionally extend through apertures (not shown) created in the diaphragm 29 at locations such that they align with the recesses 58, 61 when the cap 55 and diaphragm 29 are installed on the housing 12.

At least one of the threaded recesses 58, 61 is made from a metallic, or other suitable wear-resistant material. Such metallic or other suitable wear-resistant materials allow the mechanical fasteners 64 to be installed in a manner that secures the cap 55 to the housing 12 such that the periphery 51 of the diaphragm 29 is substantially prevented from being repositioned while the cap 55 is in place. Further, the metallic or other suitable wear-resistant material experiences minimal damage due to forces exerted by the mechanical fasteners 64 on the threaded portion.

A valve stem 67 is operatively coupled to the diaphragm 29 to rise and fall axially along axis 69 (FIG. 3) as the position of the diaphragm 29 is adjusted. The valve stem is provided at one end with a washer 71 and at an opposite end with a plunger 74. The washer 71 encircles a portion of the valve stem 67 extending through the diaphragm 29 and into an actuation chamber 77 for accepting and releasing a fluid (not shown) to adjust the position of the diaphragm 29. According to the illustrative embodiment, the diaphragm valve 10 is pneumatically actuated, meaning air is introduced to, and removed from, the actuation chamber 77 to adjust the position of the diaphragm 29 between the first and second positions. Air introduced into the actuation chamber 77 through an aperture 81 in the cap 55 creates a sufficiently high pressure in the actuation chamber 77 to force the washer 71 and the diaphragm 29, away from the actuation chamber 77. This results in the diaphragm 29 being adjusted to the second position as shown in FIG. 3. Similarly, air removed from the actuation chamber 77 through the aperture 81 causes the pressure in the actuation chamber 77 to fall to a sufficiently low level to return the diaphragm 29 to the first position shown in FIG. 2. Air, and/or any other fluid to be introduced into the actuation chamber 77 to adjust the position of the diaphragm 29 can be introduced by means other than the aperture 81 in the cap. The fluid can be introduced through an interior passage (not shown) formed within the housing 12, for example.

FIG. 3 illustrates the diaphragm 29 adjusted to the second, or seated position commonly referred to as the closed position. When the diaphragm 29 is adjusted to this position, a surface of the diaphragm 29 communicates with a seat 84 projecting from the housing 12 into the interior passage. Communication between the seat 84 and the diaphragm 29 substantially prevents the flow of the fluid through the through portion 35 beyond the diaphragm 29 and out of one of the first and second ports 14, 18. The seat 84 and the washer 71 are compatibly shaped so that the washer 71 forms the diaphragm 29 to conform to a contour of the seat 84, thereby forming an interface through which the flow of the fluid is minimized while the diaphragm 29 is in the second position. At least a portion of the housing 12 is made of a generally transparent material, such as a transparent plastic, for example, through which the communication between the diaphragm 29 and the seat 84 can be observed to monitor any leaks that may occur. According to the illustrative embodiment, the entire housing 12, including the cap 55, is made from the generally transparent material, with the exception of the metallic threaded recesses 58, 61.

With the diaphragm 29 in the second position, fluid entering one of the first and second ports 14, 18 is generally prevented from flowing in the through portion 35 beyond the interface between the seat 84 and the diaphragm 29. Thus, the amount of fluid exiting the diaphragm valve 10 through the port 14, 18 on an opposite side of the through portion 35 while the diaphragm 29 is adjusted to the second position is minimal, and ideally none. Instead, pressure from fluid that is continuously entering the diaphragm valve 10 through one of the first and second ports 14, 18 forces the fluid into the branched portion 38 via the aperture 42 and out of the diaphragm valve 10 through the third port 22. The aperture 42 is open as a result of the valve stem 67 having been axially adjusted downwardly toward the third port 22 with the adjustment of the diaphragm 29. While the valve stem 67 is so adjusted, the plunger 74 is positioned away from the aperture 42, thereby allowing the fluid to flow through the branched portion 38 and out through the third port 22.

While the illustrative embodiment is described as having the fluid entering the diaphragm valve 10 through one of the first and second ports 14, 18 and exiting the diaphragm valve 10 through the third port 22, this is not the only fluid flow path through the diaphragm valve 10 of the present invention. The fluid can enter the diaphragm valve 10 through any of the ports 14, 18, 22, and exit the diaphragm valve 10 through any of the ports 14, 18, 22 through which the fluid is not entering the diaphragm valve 10. Further, the flow of the fluid through the diaphragm valve 10 is reversible. Thus, in an embodiment where the fluid enters the diaphragm valve 10 through the third port 22 and exits through the first port 14, the flow can be reversed as desired so that the fluid enters the diaphragm valve 10 through the first port 14 and exits through the third port 22. The same is true of fluid flowing through the ports 14, 18 on opposite ends of the through portion 35.

FIGS. 2, 3 and 4 illustrate a plurality of fins 87 projecting inwardly from the housing 12 and extending axially within the branched portion 38 of the interior passage 26 to provide radial support to the valve stem 67. Turbulently flowing fluid can impart forces on the valve stem 67 as the fluid passes through the branched portion 38, causing the valve stem 67, or a portion thereof, to contact the housing 12 in the absence of the fins 87. The radial support from the fins 87 prevents a portion of the valve stem 67 and/or the plunger 74 from contacting the housing 12 while the valve stem 67 is extended into the branched portion 38. According to the illustrative embodiment, four fins 87 are spaced approximately 90 degrees from each other on the housing 12 around the branched portion 38 of the interior passage 26. However, similar projections other than fins, such as ribs, braces, and even the housing 12 itself, in any number and arrangement, can extend axially within the branched portion 38 in a manner to stabilize the valve stem 67 therein. Further, the fins 87 may engage any portion of the valve stem 67 and/or plunger 74 to provide radial support to the valve stem 67, while minimizing the impedance to the flow of fluid through the branched portion 38.

In operation, the diaphragm valve 10 can be initially actuated such that the diaphragm 29 is in either the first position, the second position, or in any position between the first and second positions. FIG. 2 illustrates the diaphragm valve 10 with the diaphragm 29 adjusted to the first position. With the diaphragm 29 in the first position, the valve stem 67 is raised to its uppermost position, locating at least a portion of the plunger 74 within the aperture 42. The plunger 42 generally prevents the fluid entering the diaphragm valve 10 from flowing in either direction through the aperture 42. Thus, the fluid exits the diaphragm valve 10 through one of the first and second ports 14, 18 by way of the through portion 35.

When it is desired to discharge the fluid entering one of the first and second ports 14, 18 through the third port 22, the position of the diaphragm 29 is adjusted to the second position by introducing the actuation fluid into the actuation chamber 77 through the aperture 81 in the cap 55. According to the illustrative embodiment, air is introduced as the actuation fluid since the diaphragm valve 10 has been described as pneumatically actuated. The building pressure in the actuation chamber 77 forces the diaphragm 29 into the through portion 35 of the interior passage 26 until the pressure is sufficient to bring the diaphragm 29 into communication with the seat 84. After said communication has been established, the pressure within the actuation chamber 77 is maintained at a suitably high level to minimize the leakage of fluid through the interface between the diaphragm 29 and the seat 84. FIG. 3 illustrates the diaphragm 29 adjusted to the second position. While the diaphragm 29 is making the transition from the first position to the second position, the plunger 74 is translated axially within the branched portion 38, along with the valve stem 67, toward the third port 22. Once the plunger 74 is removed from the aperture 42, the fluid can flow through the aperture 42 to exit the diaphragm valve 10 through the third port 22 by way of the branched portion 38.

During and after the translation of the valve stem 67 and plunger 74 in the axial direction into the branched portion 38, the fins 87 provide radial support to the valve stem 67 to prevent any portion of the valve stem 67 in the branched portion from contacting the housing 12. The fluid flowing through the branched portion 38 flows around the supported valve stem 67 and plunger 74 as it approaches the third port 22. Noise typically produced by contact between the valve stem 67 and/or plunger 74 is minimized due to the radial support provided by the fins 87.

Fluid leaking between the diaphragm 29 and the seat 84 while the diaphragm 29 is in the second position can be observed through the at least portion of the housing 12 formed from the generally transparent material. Further, the at least portion of the housing 12 formed from the generally transparent material is disposed such that at least one of the following can be observed while the diaphragm pump 10 is operating: the position of the diaphragm 29, the communication between the diaphragm 29 and the seat 84, the seat 84, one or more of the fins 87, the valve stem 67, the engagement of the valve stem 67 and/or plunger 74 by one or more of the fins 87, and any combination thereof. In the case where the entire housing 12 is made from the generally transparent material, all of the above listed items as well as internal items of the diaphragm valve 10 not listed may be observable while the diaphragm valve 10 is operational.

From the above description of the invention, those skilled in the art will perceive improvements, changes and modifications. Such improvements, changes and modifications within the skill of the art are intended to be covered by the appended claims.

1. A diaphragm valve for selectively directing a fluid to one or more of a plurality of destinations, the diaphragm valve comprising:
a first port through which the fluid is to enter or exit the diaphragm valve to be directed to one or more of the plurality of destinations;
a second port through which the fluid is to exit the diaphragm valve en route to a first destination;
a third port through which the fluid is to exit the diaphragm valve en route to a second destination;
a diaphragm adjustable between a first position and a second position, wherein
the fluid that enters the diaphragm valve will be discharged from the diaphragm valve generally through the second port while the diaphragm is positioned at the first position, and
the fluid that enters the diaphragm valve will be discharged from the diaphragm valve generally through the third port while the diaphragm is positioned at the second position; and
a housing having at least a portion made from a transparent material such that the diaphragm is visible during operation of the valve, wherein
the housing defines an interior passage between the first, second and third ports.

2. The diaphragm valve according to claim 1 further comprising a valve stem operatively connected to the diaphragm to extend into a branched portion of the interior passage.

3. The diaphragm valve according to claim 2, wherein the valve stem includes a plunger that cooperates with an aperture within the diaphragm valve while the diaphragm is positioned at the first position, the communication between the plunger and the aperture substantially preventing the flow of the fluid between at least one of the first and second ports and the third port.

4. The diaphragm valve according to claim 2, wherein a position of the valve stem is axially extended into the branched portion of the interior passage while the diaphragm is positioned at the second position.

5. The diaphragm valve according to claim 4 further comprising a plurality of fins disposed on the housing and extending axially along the branched portion of the interior passage to provide radial support to the valve stem while the valve stem is extended into the interior passage adjacent to the third port.

6. The diaphragm valve according to claim 1 further comprising a plurality of fins disposed on the housing and extending axially along a branched portion of the interior passage.

7. The diaphragm valve according to claim 1, wherein the housing includes a removable cap made from a transparent material.

8. The diaphragm valve according to claim 1, wherein the housing includes a threaded portion to receive a compatibly threaded fastener to secure the diaphragm to the housing.

9. The diaphragm valve according to claim 8, wherein the threaded portion of the housing is made from a metal.

10. The diaphragm valve according to claim 1 further comprising a seat disposed to communicate with the diaphragm when the diaphragm is positioned at the second position to direct the fluid between the first and third ports while generally preventing the flow of the fluid through the second port.

11. The diaphragm valve according to claim 10, wherein the communication between the diaphragm and the seat is visible through the at least portion of the housing made from the transparent material.

12. The diaphragm valve according to claim 1, wherein the diaphragm is pneumatically adjusted to the first and second positions.

13. The diaphragm valve according to claim 1, wherein the interior passage defined by the housing includes a linear portion having a branched portion extending generally perpendicularly from the linear portion.

14. The diaphragm valve according to claim 1, wherein the first port is coaxial with the second port.

15. A diaphragm valve for selectively directing a fluid to one or more of a plurality of destinations, the diaphragm valve comprising:
a first port through which the fluid is to enter the diaphragm valve to be directed to one or more of the plurality of destinations;
a second port through which the fluid is to exit the diaphragm valve en route to a first destination;
a third port through which the fluid is to exit the diaphragm valve en route to a second destination;
a diaphragm adjustable between a first position and a second position, wherein
the fluid that enters the diaphragm valve will be discharged from the diaphragm valve generally through the second port while the diaphragm is positioned at the first position, and
the fluid that enters the diaphragm valve will be discharged from the diaphragm valve generally through the third port while the diaphragm is positioned at the second position; and
a plastic housing having a metallic threaded portion to receive a compatibly threaded fastener to secure a periphery of the diaphragm to the housing.

16. The diaphragm valve according to claim 15 further comprising a valve stem operatively connected to the diaphragm to extend into a branched portion of the interior passage.

17. The diaphragm valve according to claim 16, wherein the valve stem includes a plunger that cooperates with an aperture within the diaphragm valve while the diaphragm is positioned at the first position, the communication between the plunger and the aperture substantially preventing the flow of the fluid between at least one of the first and second ports and the third port.

18. The diaphragm valve according to claim 16, wherein a position of the valve stem is axially extended into the branched portion of the interior passage while the diaphragm is positioned at the second position.

19. The diaphragm valve according to claim 18 further comprising a plurality of fins disposed on the housing and extending axially along the branched portion of the interior passage to provide radial support to the valve stem while the valve stem is extended into the interior passage adjacent to the third port.

20. The diaphragm valve according to claim 15 further comprising a plurality of fins disposed on the housing and extending axially along a branched portion of the interior passage.

21. The diaphragm valve according to claim 15, wherein the housing includes a removable cap made from a transparent material.

22. The diaphragm valve according to claim 15 further comprising a seat disposed to communicate with the diaphragm when the diaphragm is positioned at the second position to direct the fluid through the third port while generally preventing the flow of the fluid through the second port.

23. The diaphragm valve according to claim 22, wherein the communication between the diaphragm and the seat is observable through at least a portion of the housing made from a transparent material.

24. The diaphragm valve according to claim 15, wherein the diaphragm is pneumatically adjusted to the first and second positions.

25. The diaphragm valve according to claim 15, wherein the housing is made from a transparent plastic.

26. The diaphragm valve according to claim 25 wherein the diaphragm is visible through the transparent plastic during operation of the diaphragm valve.

27. The diaphragm valve according to claim 15, wherein the interior passage defined by the housing includes a linear portion having a branched portion extending generally perpendicularly from the linear portion.

28. The diaphragm valve according to claim 15, wherein the first port is coaxial with the second port.

29. A diaphragm valve for selectively directing a fluid to one or more of a plurality of destinations, the diaphragm valve comprising:
a first port through which the fluid is to enter the diaphragm valve to be directed to one or more of the plurality of destinations;
a second port through which the fluid is to exit the diaphragm valve en route to a first destination;
a third port through which the fluid is to exit the diaphragm valve en route to a second destination;
a diaphragm adjustable between a first position and a second position, wherein
the fluid that enters the diaphragm valve will be discharged from the diaphragm valve generally through the second port while the diaphragm is positioned at the first position, and
the fluid that enters the diaphragm valve will be discharged from the diaphragm valve generally through the third port while the diaphragm is positioned at the second position;
a housing defining an interior passage through which the fluid that enters the diaphragm valve will travel to exit the diaphragm valve through at least one of the second and third ports; and
a plurality of fins disposed on the housing and axially extending along a branched portion of the interior passage.

30. The diaphragm valve according to claim 29 further comprising a valve stem operatively connected to the diaphragm to extend into the branched portion of the interior passage.

31. The diaphragm valve according to claim 30, wherein the valve stem includes a plunger that cooperates with an aperture within the diaphragm valve while the diaphragm is positioned at the first position, the communication between the plunger and the aperture substantially preventing the flow of the fluid between at least one of the first and second ports and the third port.

32. The diaphragm valve according to claim 30, wherein a position of the valve stem is axially extended into the branched portion of the interior passage while the diaphragm is positioned at the second position.

33. The diaphragm valve according to claim 29, wherein the housing includes a removable cap made from a transparent material.

34. The diaphragm valve according to claim 29, wherein the housing includes a threaded portion to receive a compatibly threaded fastener to secure the diaphragm to the housing.

35. The diaphragm valve according to claim 34, wherein the threaded portion of the housing is made from a metal.

36. The diaphragm valve according to claim 29 further comprising a seat disposed to communicate with the diaphragm when the diaphragm is positioned in the second position to direct the fluid between the first and third ports while generally preventing the flow of the fluid between the first and second ports.

37. The diaphragm valve according to claim 36, wherein the communication between the diaphragm and the seat is visible through the at least portion of the housing made from the transparent material.

38. The diaphragm valve according to claim 29, wherein the diaphragm is pneumatically adjusted to the first and second positions.

39. The diaphragm valve according to claim 29, wherein the interior passage defined by the housing includes a linear portion having a branched portion extending generally perpendicularly from the linear portion.

40. The diaphragm valve according to claim 29, wherein the plurality of fins includes four (4) fins that are separated by approximately ninety (90) degrees from each other on the housing.

41. The diaphragm valve according to claim 29, wherein the first port is coaxial with the second port.

42. A diaphragm valve for selectively directing a fluid to one or more of a plurality of destinations, the diaphragm valve comprising:
a first port through which the fluid is to enter the diaphragm valve to be discharged at one or more of the plurality of discharge locations;
a second port through which the fluid is to exit the diaphragm valve at a first discharge location;
a third port through which the fluid is to exit the diaphragm valve at a second discharge location;
a diaphragm adjustable between a first position and a second position, wherein
the fluid that enters the diaphragm valve will be discharged from the diaphragm valve generally through the second port while the diaphragm is positioned at the first position, and
the fluid that enters the diaphragm valve will be discharged from the diaphragm valve generally through the third port while the diaphragm is positioned at the second position;
a transparent plastic housing defining an interior passage through which the fluid that enters the diaphragm valve will travel to be discharged from at least one of the second and third ports;
a plurality of fins disposed on the housing and axially extending along a branched portion of the interior passage; and
a metallic threaded portion provided to the housing to cooperate with a compatibly threaded fastener to secure a periphery of the diaphragm to the housing.
